(19) United States
(12) Patent Application Publication
(10) Pub. No.: US 2024/0198388 A1
(43) Pub. Date: Jun. 20, 2024

(54) SYSTEM AND METHOD FOR MANAGING RAW MATERIALS OF INDUSTRIAL IMPORTANCE

(71) Applicant: SECURITY MATTERS LTD., D.N. Hevel Eilot (IL)

(72) Inventors: Tehila NACHUM, Holon (IL); Nataly TAL, Nes Ziona (IL); Mor KAPLINSKY, Herzelia (IL); Hagit SADE, Ramat Gan (IL); Haggai ALON, Kibbutz Naan (IL); Ron DAFNI, Tel Aviv (IL); Chen NACHMIAS, Tel Aviv (IL); Gal SHMUELI, Or Yehuda (IL); Yonatan MUSNIKOW, D.N. Hevel Eilot (IL); Nadav YORAN, Tel Aviv (IL); Yekaterina ZELDICH, Petach Tikva (IL); Michal BURCK ZALTZMAN, Tel Aviv (IL); Michal FIRSTENBERG, Rehovot (IL)

(21) Appl. No.: 18/556,392

(22) PCT Filed: Apr. 13, 2022
(86) PCT No.: PCT/IL2022/050381

§ 371 Date: Oct. 20, 2023

Related U.S. Application Data
(60) Provisional application No. 63/260,293, filed on Aug. 16, 2021.

(30) Foreign Application Priority Data
Apr. 21, 2021 (IL) 282500

(51) Int. Cl. B07C 5/34; B07C 5/346; C08J 3/22

(52) U.S. Cl. CPC B07C 5/3412; B07C 5/346; C08J 3/22; B07C 2501/0054; C08J 2307/00

(57) ABSTRACT

Method and system are presented for managing material recycling process. Plastic and rubber material condition data is provided being indicative, for each of one or more plastic materials in a product, of preceding use of said plastic material in association with one or more plastic product types. The plastic material condition data is analyzed, and sorting data is generated for each of said one or more plastic materials. Based on the sorting data, marking data is generated for at least one of said one or more plastic materials, the marking data including at least one marker to be introduced into each of said one or more plastic materials to provide electromagnetic radiation signal for managing a recycling process of the plastic material. At least one of the plastic material condition data and the sorting data is analyzed, and certificate data is generated and stored charactering a current condition of said plastic material to be sorted.

### TECHNICAL FIELD

The presently disclosed subject matter is in the field of material manufacturing and industrial use of raw materials. The invention is particularly useful for managing material recycling processes, e.g. plastic materials recycling.

### BACKGROUND

Plastic is one of the world's most-used materials. The problem with plastic lies not in how it is used but in end-of-life management of products made from it. Currently, only a small percentage of the plastic is recycled or reused, while most of the plastic ends up as waste in landfills or worse, dumped in the wild and/or finds its way to the oceans. Due to this growing problem, there is an urgent need for recycling and reuse of plastic products.

A major problem in recycling plastic products is the degradation of plastic materials (e.g., polymeric materials) during their use and furthermore during the recycling process thereof, that might affect their properties, such as for example, strength, elasticity, optical and thermal properties, resistance against UV irradiation, etc. Recycled plastic materials and/or products made from recycled plastic materials, may therefore be of a lower quality, compared to non-recycled plastic materials. Moreover, the quality of a plastic material usually decreases with every recycling process the material undergoes. That is, a plastic material that was incorporated in a product which was recycled and reused, in the same type of product or a different product, may be of a lower quality than plastic material which underwent a recycling process only once for example. Plastic material that has undergone a number of “allowed” recycling stages for use in the same type of product might not be useful anymore in said product type, while when being further recycled might be suitable for making therefrom a product of another type.

### GENERAL DESCRIPTION

The present invention provides a novel approach for proper marking of raw materials and for managing the recycling and reuse of various materials comprising such marked raw materials, in particular plastic materials, for the duration of several life cycles in several products of the same or different types, by timely performing decision making and generating corresponding sorting data for each plastic material and preferably also generating a corresponding certificate assigned to said plastic material. Such sorting data, generated based on real time inspection of the properties/conditions of the raw material as well as of each plastic material, is indicative of whether successive recycling of said plastic material allows its further use in a product, and the suitable product type.

The technique of the present invention enables automatic inspection and sorting of plastic material(s) containing products progressing on a production line. A management system of the present invention, which generates the sorting data and the associated assigned certificate data based on the material inspection data, may be part of the inspection station or may be a stand-alone system in data communication with the inspection station. The sorting/certificate data can then be properly accessed and used at a sorting station downstream of the inspection station.

The present invention takes advantage of earlier technique developed by the inventors of the present application for reading electromagnetic radiation signature(s) of plastic material(s) (e.g. in response to certain irradiation), e.g. based on specific marking(s) embedded in the plastic material(s), and determining properties/conditions of each plastic material from the detected signature.

Life cycle of a plastic material refers to the period from manufacturing of the material (as a virgin plastic material or recycled plastic material) until the next recycling of the plastic material. Marking of the plastic material may be already during its manufacturing or at any stage thereafter.

Production of plastic products may utilize a composition of natural products, such as natural rubber or similar products and compositions of such natural products (unrecycled products), and one or more recycled plastic materials, wherein the natural plastic material may be a plastic material which was not recycled (e.g., virgin) but used in a product for the first time. The properties/conditions of a specific plastic material (whose further recycling or reuse is to be decided about) can be determined based on the readings of the radiation signature of the plastic material itself or may be determined based on a relation between (e.g. preselected proportions of) natural and recycled plastic materials in a product being inspected. This way, plastic products may be produced from a composition of materials having a preselected ratio between natural plastic material and one or more recycled plastic materials, in accordance with specific product requirements, while ensuring quality thereof. In some cases, the recycled plastic material may be set to include preselected concentrations of plastic material which underwent recycling once, twice or more times. In order to allow large scale recycling and reuse of specific plastic materials, detection and identification of natural and recycled plastic materials is used.

Various plastic materials (e.g. polymeric materials) are marked during a recycling process (that is, during the production of recycled plastic material/product originating from used plastic products). Additionally, the plastic material may be marked as a virgin plastic during its production or the production of plastic products in which the virgin plastic is the main component.

While plastic materials are typically industrially made polymeric materials and rubber is a natural material, for the purposes of the invention disclosed herein, the term “plastic” encompasses natural and non-natural or industrially manufactured polymers. Thus, the plastic materials may be polymers, such as Low Density Polyethylene (LDPE), Linear Low Density Polyethylene (LLDPE), High Density Polyethylene (HDPE), Polypropylene (PP), Polyisoprenes, natural rubber (or latex) and other type of polymers.

The plastic materials are marked by specific markings (marker elements) that are embedded in the plastic materials. The markers may respond to exciting/reading radiation by emission of an electromagnetic signal which may be detected by a suitable spectrometer (reader). In an example, the markers' response to incoming electromagnetic radiation mat, for example, include UV radiation, X-ray diffraction (XRD), or X-ray fluorescence (XRF).

Thus, the marked plastic material is characterized by a signature generated in response to the exciting/reading radiation. In the description below, the use of XRF technique is exemplified with regards to readings of the plastic material signature in order to determine the plastic material properties/conditions and with regard to marking the plastic material in accordance with its sorting data and certificate. It should however be understood that the principles of the novel approach of the present invention are not limited to this specific type of signature/marking.

XRF markers may be detected and measured by X-Ray Fluorescence (XRF) analysis by XRF spectrometers (readers) which may detect and identify their response (signature) signals. In an example, the XRF readers are Energy Dispersive X-Ray fluorescence (EDXRF) spectrometers. XRF markers are flexible, namely, they may be combined, blended or form compounds with, or embedded within a huge range of carriers, materials, substances, and substrates, without negatively affecting their signature signals.

The XRF markers may be, for example, in the form of inorganic salts, metal oxides, bi or tri metal atom molecules, polyatomic ions, and organometallic molecules (as described for instance in WO21009758 and WO21009757 which are assigned to the assignee of the present application and are incorporated herein by reference). In an example, XRF markers may be blended or applied to inorganic material (e.g. metals) or with organic (e.g. polymeric) materials, as described in WO 2018/069917 which is assigned to the assignee of the present application and is incorporated herein by reference.

Due to this flexibility, the XRF markers, or a marking composition including several XRF markers (possibly with additional materials, such as carriers or additives), may be designed to have a preselected set of properties. Additionally, XRF marking can be detected and identified when markers are present under the surface of an object but not on the surface itself, for instance, when the object is covered by a packaging material, dirt or dust. Furthermore, XRF analysis enables measurement of the concentration of the markers present within a material as well as the ratio (the relative concentration) of the markers within a material.

The present invention provides a novel approach for overcoming problems relating to recycling and reuse of plastic materials. In particular, the present invention enables the marking and identification of virgin polymeric or material polymers, such as natural polymers as rubber, and recycled plastic materials. Moreover, the technique of the present invention allows to identify the number of time the polymeric material has undergone recycling. Furthermore, in case of a product which includes both virgin material(s) and recycled plastic material, the composition of the product can be determined, namely, by measurement of a relation (e.g. ratio) between the virgin material, plastic material recycled once, plastic material recycled twice, and so on. To this end, a set of one or more markers are introduced to the recycled material in each round of a recycling process during the overall recycling processes. Additionally, according to the invention, a virgin material may also be marked by one or more markers which may be introduced into the virgin material, for example, during its manufacturing or during the polymerization process, the compounding process, or during hot melt processing (e.g. extrusion) for instance during a production of a product containing the virgin material.

The one or more markers are embedded within a plastic material to obtain a marked plastic material and may be detected and identified (e.g. by XRF analysis) at any stage during the life cycle of the marked plastic material, e.g. in the physical form of pellets, or as a component of a product, and during and after production of the product.

Thus, according to one broad aspect of the invention, it provides a method for providing an XRF-identifiable polymeric raw material, such as natural rubber, the method comprising marking a sample of the polymeric raw material with an amount of an XRF-identifiable marker, the amount defining an electromagnetic radiation signature indicative of the raw material composition and/or production profile (the raw material data). The profile may include one or more dates of manufacture, site of manufacture, composition, presence or absence of unnatural additives, etc.

One of the major virgin materials used in accordance with the invention is natural rubber or latex.

As known in the art, natural rubber is made by extracting a liquid sap, latex, from certain types of trees, mainly from Hevea brasiliensis trees, or the aptly named rubber tree. Latex is gathered from the trees by making a cut in the bark and collecting the runny sap in cups. This process is called tapping. In order to prevent the sap from solidifying, ammonia is added. Acid is then added to the mix to extract the rubber, in a process called coagulation. The mixture is then passed through rollers to remove excess water. Once this is complete, the layers of rubber are hung over racks in smokehouses or left to air dry. Several days later, they will then be folded into bales ready for processing.

In accordance with the present invention, the rubber may be marked as detailed herein with an XRF-identifiable marker at any stage of its production. Where the rubber is mixed with at least one another material, the rubber is marked prior to mixing with the at least one another material.

Marking may be during the stage latex collection, i.e., during tapping; prior to, during or after sap solidification with a solidification agent; prior to, during or after coagulation; or after the rubber is dried.

According to another broad aspect of the invention, it provides a product comprising a composition of a natural unrecycled product and one or more recycled plastic materials, wherein at least one of the natural unrecycled product and the recycled plastic materials comprises at least one predetermined marker capable of responding to exciting radiation by a characteristic radiation signature, embedding data indicative of one or more properties and conditions of said composition detectable from readings of said radiation signature of said at least one marker.

The invention also provides a method of managing material recycling process, the method comprising:
providing first measured data indicative of one or more first electromagnetic radiation signatures embedded in one or more plastic materials in a product;
analyzing the measured data to determine, for each of said one or more plastic materials, a respective plastic material condition data, wherein the respective plastic material condition data is indicative of preceding use of said plastic material;
generating first sorting data for each of said one or more plastic materials, based on the respective plastic material condition; and
generating marking data for at least one of said one or more plastic materials, based on the first sorting data, wherein the marking data includes data indicative of at least one marker to be introduced into each of said one or more plastic materials to provide electromagnetic radiation signal for managing a recycling process of said one or more plastic materials.

In some embodiments, the method further comprises utilizing at least one of the plastic material condition data and the sorting data of said plastic material, and generating and storing certificate data characterizing a current condition of said plastic material to be sorted.

The data indicative of the at least one marker may be obtained from a database, storing, for each plastic material reuse type, data indicative of a life cycle of said plastic material in association with matching data about corresponding one or more markers.

The data indicative of the at least one marker may comprise data corresponding to (a) a number of a successive life cycle of said plastic material being recycled and (b) a successive product type for reuse of recycled plastic material.

In some embodiments, the plastic material condition data is indicative of a relation between contents of said plastic material and a predetermined natural material (e.g. virgin material such as rubber) in the product. For example, the first measured data also comprises data indicative of one or more electromagnetic radiation signatures detected from said predetermined natural material, as defined herein.

The one or more plastic materials may comprise at least one polymeric material.

In some embodiments, the providing of the first measured data comprises communicating with a measured data provider to receive said first measured data from the measured data provider. Alternatively or additionally, providing of the first measured data comprises performing one or more measurement sessions on said product to be sorted to identify said one or more first electromagnetic radiation signatures and generate the first measured data indicative thereof.

In some embodiments, the method further comprises communicating the marking data to a marking system configured and operable to be responsive to the marking data in association with the one or more plastic materials in the product, and performing one or more marking sessions to introduce said at least one marker into each of said one or more plastic materials.

In some embodiments, the method further comprises utilizing said marking data in association with the one or more plastic materials in the product and operating a marking system to perform one or more marking sessions to introduce said at least one marker into each of said one or more plastic materials.

The at least one marker may be introduced into the plastic material in a single package together with additional additives in a single masterbatch.

In some embodiments, the method further comprises providing second measured data indicative of one or more second electromagnetic radiation signals originated by one or more contaminant elements presented in the plastic material after being sorted by introducing said marking therein.

In some embodiments, the method further comprises providing second measured data indicative of one or more second electromagnetic radiation signals originated by one or more contaminant elements presented in the plastic material after being sorted by introducing said marking therein, and updating the certificate data characterizing the plastic material.

The second measured data may be provided by communicating with a measured data provider to receive said second measured data from the measured data provider. Alternatively or additionally, the second measured data may be provided by performing one or more measurement sessions on said product after being sorted to identify the one or more second electromagnetic radiation signatures and generate the second measured data indicative thereof.

In some embodiments, the method further comprises providing verification data indicative of composition of the plastic material being recycled based on said marking data embedded in the plastic material; analyzing the verification data and generating control data characterizing at least one of the following: the recycling process of said plastic material; a production process of a product comprising the recycled plastic material.

The verification data may be provided by measuring electromagnetic radiation signals originated in the plastic material being recycled based on said marking data embedded in the plastic material.

The electromagnetic radiation signals of the measured data may be of at least one of the following types: UV signals; X-Ray Diffraction (XRD) signals; X-Ray Fluorescence (XRF) signals.

Preferably, the electromagnetic radiation signals of the measured data comprise X-Ray Fluorescence (XRF) signals; and the data indicative of the at least one marker corresponds to the at least one marker responding by XRF response signals to XRF exciting radiation.

According to yet another broad aspect of the invention, it provides a method for managing material recycling process comprising:
providing plastic material condition data indicative, for each of one or more plastic materials in a product, of preceding use of said plastic material in association with one or more plastic product types;
analyzing the plastic material condition data and generating sorting data for each of said one or more plastic materials, based on the respective plastic material condition;
generating marking data for at least one of said one or more plastic materials, based on the sorting data, wherein the marking data includes at least one XRF marker to be introduced into each of said one or more plastic materials to provide electromagnetic radiation signal for managing a recycling process of the plastic material; and
utilizing at least one of the plastic material condition data and the sorting data of said plastic material, and generating and storing certificate data charactering a current condition of said plastic material to be sorted.

According to yet further broad aspect of the invention there is provided a management system for use in managing material recycling process, the system being configured as a computer system comprising data input and output utilities, a memory and a processing circuitry, wherein:
the data input utility is configured to receive input data comprising first measured data indicative of one or more electromagnetic radiation signatures originated in one or more plastic materials in a product;
said processing circuitry comprises:
an analyzer configured and operable to be responsive to the first measured data to analyze it and determine, for each of said one or more plastic materials, a respective plastic material condition indicative of preceding use of said plastic material;
a sorting data generator configured and operable to determine sorting data for each of said one or more plastic materials, based on the respective plastic material condition; and
a marking data generator configured and operable to determine marking data for each of said one or more plastic materials, based on the sorting data, wherein the marking data includes at least one marker to be introduced into each of said one or more plastic materials to provide electromagnetic radiation signal for managing a recycling process of the plastic material.

The management system may be configured and operable to communicate with a measured data provider to receive the measured data from the measured data provider; and/or may be configured and operable to communicate the marking data to a marking system configured and operable to perform one or more marking session to introduce said at least one marker into each of said one or more plastic materials.

In some embodiments, the management system includes a measurement unit configured and operable to perform one or more measurement sessions on said product to identify said one or more signatures and generate the first measured data indicative thereof.

In some embodiments, the management system includes a marking unit configured and operable to perform one or more marking sessions to introduce said at least one marker into each of said one or more plastic materials.

Preferably, the management system (its processing circuitry) further comprises a certificate generator utility configured and operable to utilize at least one of the plastic material condition data and the sorting data of said plastic material, and generate and store certificate data charactering a current condition of said plastic material to be sorted.

In some embodiments, the management system is configured and operable to communicate with a database manager system associated with a database storing, for each plastic material reuse type, data indicative of a life cycle of said plastic material in association with matching data about corresponding one or more markers, to obtain from said database manager system data indicative of the at least one marker.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram of an exemplary system of the invention for managing plastic material recycling process;

FIG. 2 is a block diagram schematically illustrating an example of the configuration and operation of a database manager system suitable to be used with the present invention;

FIG. 3 is a flowchart exemplifying a method of the invention for managing materials recycling process; and

FIGS. 4, 5 and 6 show flow diagrams of three more examples of the technique of the present invention.

### DETAILED DESCRIPTION OF EMBODIMENTS

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “providing”, “analyzing”, “generating”, “updating”, “communicating”, “receiving” or the like, include action and/or processes of a computer that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer system specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

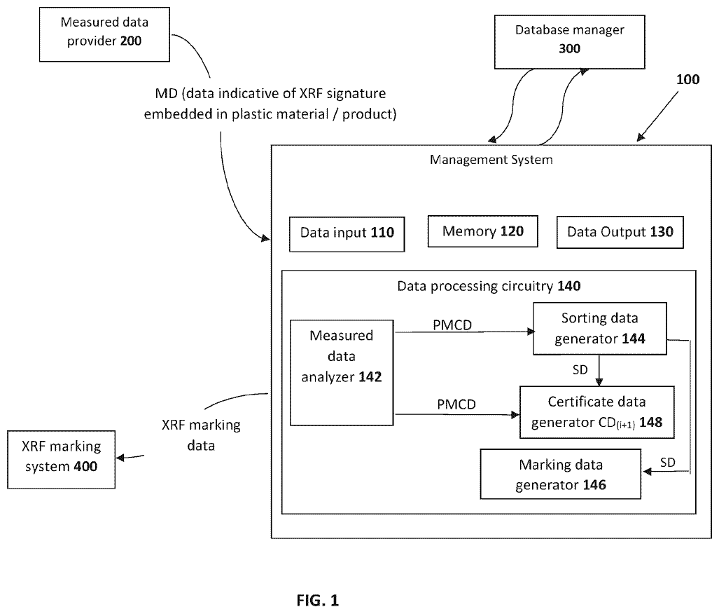

FIG. 1 illustrates, by way of a block diagram, a system 100 configured and operable in accordance with the presently disclosed subject matter. Each module/utility in FIG. 1 can be made up of any combination of software, hardware and/or firmware that performs the functions as defined and explained herein. The modules/utilities in FIG. 1 may be centralized in one location or dispersed over more than one location, as detailed herein. In other embodiments of the presently disclosed subject matter, the system may comprise fewer, more, and/or different modules than those shown in FIG. 1.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

According to of the technique the presently disclosed subject matter, plastic materials may be marked during a recycling process thereof (e.g., during a production of recycled polymeric material originating from used one or more plastic products). Additionally, the plastic material composition may include one or more natural (e.g., virgin) material (e.g., polymeric) such as rubber or latex introduced during the production of a plastic product, in which the natural material is the unused component which has not been recycled.

Plastic material composition of a product may include for example one or more polymers, such as but not limited to, Low Density Polyethylene (LDPE), Linear Low-Density Polyethylene (LLDPE), High Density Polyethylene (HDPE), Polypropylene (PP), Polyamide 6 Volgamid® 27, or any other type of one or more polymeric materials that may be suitable for use in a product of a specific type. Natural rubber, latex and related materials may also be used, particularly as the virgin materials.

According to the presently disclosed subject matter, the plastic material(s) used or virgin, as defined are marked by one or more marker elements that may be embedded in the plastic material or presented on its surface. These marker elements are of the type responding, by electromagnetic radiation response, to exciting radiation enabling detection of the response signal by a suitable reader (e.g., a spectrometer, etc.). For example, such marking technique may be based on reading Ultraviolet (UV) response signals or X-ray response signals, e.g., X-Ray Diffraction (XRD) response signals or X-Ray Fluorescence (XRF) response signals.

More specifically, the presently disclosed subject matter is particularly useful for marking elements by XRF markers and reading XRF signatures of marked plastics, and therefore the presently disclosed subject matter is exemplified hereinbelow with respect to this specific example, but it should be understood that the principles disclosed herein are not limited to XRF technique, as well as any other specific marking and reading techniques.

It should be noted that the terms marking element, XRF marking, or marker as used herein refer to an element which can be identified by XRF analysis, namely, element which responds to exciting X-ray or gamma-ray radiation (primary radiation) by emission of an X-ray response signal (secondary radiation or excited radiation) with spectral features (i.e., peaks in particular wavelength(s)) which characterize the element. In the description below, such an X-ray response signal is referred to as XRF signature. Nevertheless, it should be also noted that although reference is made in the presently disclosed subject matter to XRF markers, it is by no means limiting and the teachings herein can be applied to any other markers, mutatis mutandis. In general, said markers may emit a signal in response to incoming electromagnetic radiation, such as for example, an Ultraviolet (UV) response signal, an X-ray response signal, e.g., X-Ray Diffraction (XRD) response signal or X-Ray Fluorescence (XRF) response signal, etc. As known in the art, XRF markers may be detected and measured for example by X-Ray Fluorescence (XRF) analysis, by utilizing XRF readers (e.g., spectrometers, etc.) which may detect and measure X-ray response signals thereof (also referred to herein as “XRF signatures”). In an example, the XRF readers may be Energy Dispersive X-Ray Fluorescence (EDXRF) spectrometers.

According to the presently disclosed subject matter, there is provided a system and method for managing a recycling process and reuse of one or more plastic materials, optionally for a duration of several life cycles in one or more products. The management process includes determination, for each plastic material contained in a product, whether said plastic material may proceed for further use (i.e., further recycling stage) or not and, if so, in which type of product such recycled plastic material can be used. Thus, the product for further use of recycled plastic material may be the same type of products or different types of products.

Life cycle may be the period from manufacturing a specific plastic material until the first recycling thereof. During the manufacturing process, as well as during each recycling process, the plastic material is marked by one or more markers forming unique signature of the plastic material, which can be properly detected. In some cases, at each such stage (production and recycling), certain virgin polymeric material(s) may be introduced into plastic material composition of a product and may also be marked by one or more markers. This can be implemented for example by a polymerization process, a compounding process, a hot melt processing (e.g., extrusion), a production process of a product containing the virgin polymeric material or the like.

Thus, the one or more markers may be embedded within the plastic material to obtain a marked plastic material, thereby giving rise to a detectable and identifiable XRF signature corresponding to the plastic material status and/or condition, wherein the markers may be detected and identified at any stage during the life cycle of the marked plastic material. Accordingly, it is to be noted that the plastic material may be in a physical form of pellets or component of a product, during and/or after the production of the product.

In some cases, contaminant elements and/or impurities may be present within and/or on the surface of the plastic material (e.g., due to diffusion during use or due to contamination during production or recycling process of the plastic material). These contaminant elements and/or impurities may have a characteristic response to exciting radiation (e.g., an XRF signature) that may be measured to assist in characterizing the plastic material, or a batch of the plastic material, for or during the recycling process. The XRF signature of the contaminant elements and/or impurities may be utilized by itself or in combination with one or more markers embedded in the plastic material, to identify presence and/or proportions of the recycled plastic material vs. natural (e.g., virgin) plastic material and/or to measure the ratio between natural plastic material and recycled plastic material.

In addition, identification and measurement of one or more XRF markers enables determination of the number of times the plastic material, associated with the one or more XRF markers, has undergone recycling. In some cases, wherein a product includes natural plastic material and recycled plastic material as the main components, XRF markers embedded in the plastic materials may enable composition determination of the product (e.g., a ratio between one or more of: a virgin material, plastic material recycled once, plastic material recycled twice and so on, may be determined).

Bearing this in mind, reference is made to FIG. 1 that illustrates the system 100 for managing plastic material recycling process, in accordance with the presently disclosed subject matter.

The management system 100 is associated with a measured data provider system 200 and a database manager system 300 and possibly also with an XRF marking system 400, and is configured for data communication with these systems via communication network, by means of wired or wireless communication. The communication network may be of any known suitable type, for example and without limitation, a cellular network, a Personal Area Network (PAN) Local Area Network (LAN), a Wireless Local Area Network (WLAN), a Metropolitan Area Network (MAN), Wide Area Network (WAN), Virtual Private Network (VPN), an intranet, an extranet or an Internet.

The management system 100 is typically configured as a computer system that includes inter alia such functional utilities (software/hardware) as a data input utility 110, a memory 120, a data output utility 130, and data processor and analyzer utility (generally, a data processing circuitry) 140.

Management system 100 may be configured for data exchange with database manager system 300. For example, the management system may selectively receive (upon request) from database manager system 300 pre-stored data related to one or more plastic materials (e.g. certificate describing preceding recycling condition of the respective plastic material), and may selectively communicate to the database manager system 300 a new (successive) certificate data of said plastic material to update the database, as further described herein.

Measured data provider may be constituted by an external storage device where measured data, generated by a measurement device and being indicative of measured electromagnetic radiation signature(s) of one or more plastic materials under inspection is stored; or may be a memory utility of the measurement device. In some embodiments, management system 100 may be integral with the measurement device, as the case may be. For example, products containing one or more plastic materials are inspected while progressing on a production line through an inspection station towards a sorting station downstream of the inspection station; and the management system 100 may be part of or in data communication with the measurement device at the inspection station, and data generated by the management system may be accessed by a controller of the sorting station. In some other embodiments, the management system 100 may be part of database manager system 300 and be responsive to measured data coming from the measurement device to process and analyze the measured data to generate corresponding sorting data. In yet further embodiments, software utilities/modules of data processing circuitry 140 may be distributed between processors of the measurement device 200 and database manager system 300. Generally, the database, being either stored and managed by external manager system 300 (e.g. at a server system) and/or stored and managed by the processing circuitry of the management system 100, includes pre-stored (and properly updated) data including, inter alia, for each plastic material reuse type, data indicative of a life cycle of said plastic material in association with matching data about corresponding one or more XRF markers.

The measurement device itself may be of any known suitable type, for example as described in the above-indicated patent application incorporated herein by reference. Construction and operation of the measurement device do not form part of the present invention and therefore need not be described in details, except to note that it is capable of performing one or more measurement sessions including exciting a product/sample containing plastic material or plastic material composition, detecting electromagnetic radiation signal originated in the plastic material or plastic material composition, and generating measured data indicative of the electromagnetic radiation signature corresponding to said plastic material or plastic material composition.

Thus, management system 100 receives, via its data input utility 110, input measured data MD from the measured data provider 200. As will be described below, the measured data MD includes at least first measured data indicative of one or more electromagnetic radiation signatures (referred to herein as XRF signatures) embedded in or carried by one or more plastic materials of interest in a product or forming a product.

Such products may include virgin plastic material, plastic material recycled once, plastic material recycled twice and so on, or combinations thereof. It is to be noted that products may be, inter alia, products after production process thereof, used products before recycling, products which undergone recycling process or raw polymeric materials (e.g., virgin and/or recycled polymeric materials). In some cases, the plastic material may be the main component of the one or more products. In an example, the products may be plastic films and/or plastic packaging, that may include polymeric materials as main components therein. The polymeric materials may be for example and without limitation, low density polyethylene (LDPE), linear LDPE (LLDPE), high density polyethylene (HDPE), polyethylene terephthalate (PET), polypropylene (PP), polyamide (PA), thermoplastic polyurethane (TPU), polystyrene (PS), high impact polystyrene (HIPS), polylactic acid (PLA), polyvinylchloride (PVC), or the like.

Data being received at and/or generated in the management system 100 may be stored in memory 120.

Data processing circuitry 140 may include one or more processing units (for example and without limitation, central processing units), microprocessors, microcontrollers (for example and without limitation, microcontroller units (MCUs)) or any other computing devices or modules, including multiple and/or parallel and/or distributed processing units, which are adapted to independently or cooperatively process data for controlling relevant management system 100 resources and for enabling operations related to management system's 100 resources.

According to the invention, data processing circuitry 140 includes: an analyzer 142 configured and operable to be responsive to the measured data (at least first measured data) to analyze it and determine, for each of one or more plastic materials, a respective plastic material condition data PMCD; a sorting data generator 144 configured and operable to determine sorting data SD (at least first sorting data, as will be described below) for each of said one or more plastic materials, based on the respective plastic material condition data; a certificate data generator 148; and possibly also a marking data generator 146. The certificate data generator 148 is configured and operable to assign to each plastic material being inspected certificate data (electronic certificate), based on respective plastic material condition data PMCD directly received from analyzer 142 and/or based on sorting data SD received from sorting data generator 144.

Marking data generator 146 is configured and operable to analyze the sorting data (or certificate data) and selectively generate operational data to a marking system 400 being indicative of one or more markings to be applied to the plastic material/product to form an updated electromagnetic radiation signature of the plastic material corresponding to its current condition (in relation to its further recycling/reuse). Subsequent reading of such updated signature may be used at the sorting station to decide about further use of the plastic material.

The plastic material condition data PMCD determined by the analyzer 142 includes data indicative of the preceding use of the plastic material. Such data includes data indicative of a number of times the plastic material has undergone recycling and preferably also a type or types of products where said plastic material has been used prior to current inspection by the system 100.

The measured data MD includes one or more XRF signatures of one or more plastic materials embedded in or forming a product. In order to determine the plastic material condition data PMCD, for each specific plastic material, data processing circuitry 140 (analyzer 142) utilizes pre-stored data (e.g. data indicative of i-th XRF signature of j-th plastic material, or possibly certificate data that has been generated and stored at a preceding inspection stage of preceding i-th recycling process, being manufacturing or recycling process of said plastic material in association with a specific product type PT. To this end, the analyzer 142 may communicate with the database manager system 300 to retrieve corresponding certificate related data.

It should be noted that the measured data and/or certificate data may be properly stored, e.g. using cloud computing technology, in association with each of one or more plastic materials being inspected. As will be described below, the recycled plastic material(s) and/or products containing recycled plastic materials produced using the technique of the present invention may be further measured to detect XRF signature(s) and perform verification analyses and generation of control data for the purposes of controlling the recycling process itself and/or product production process. For example, cloud computer technology can be used to manage a ‘green’ credit system for various parties involved in the recycling, for example manufacturers of various polymeric materials or products, suppliers of polymeric materials or products, retailers of products and the end users of products. In an example the cloud system may be a distributed blockchain system.

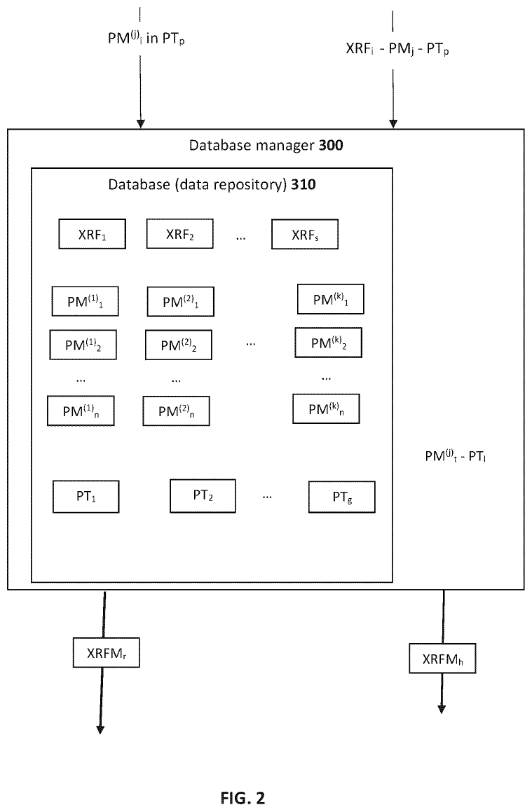

Reference is made in this respect to FIG. 2 that exemplifies, by way of a block diagram, the functional properties of a database manager system 300 suitable to be used with the present invention.

The database manager system 300 includes a data repository 310 (e.g., a database, a storage system, a memory including Read Only Memory—ROM, Random Access Memory—RAM, or any other type of memory, etc.) configured to store data, including inter alia, XRF signatures related data pieces in association with various plastic materials and certificate data thereof as well as various product types, etc. The data repository 310 is configured to enable retrieval and update of the stored data. It is to be noted that in some cases, data repository 310 can be distributed across multiple locations, whether within the management system 100 and/or elsewhere. It is to be noted, that in some cases, the relevant information relating to a specific plastic material and/or product can be loaded into data repository 310 before or after performing/receiving an XRF signal measurement of the specific plastic material and/or product.

Thus, as shown in this specific not limiting example, data repository 310 includes a plurality of S data pieces including data indicative of electromagnetic radiation signatures XRF₁, XRF₂ . . . XRFₛ that may be read from various plastic materials and/or products, e.g. based on various markings embedded in plastic materials. Further provided in the data repository 310 are plastic material related data pieces PM⁽¹⁾₁ . . . PM^{(k)}₁, PM⁽¹⁾₂ . . . PM^{(k)}₂, . . . , PM⁽¹⁾ₙ . . . PM^{(k)}ₙ, indicative, for each plastic material in a plurality of N plastic materials, of a number of allowed K recycling/reuse cycles in association with one or more plastic-based product types from a plurality of G product types PT₁ . . . PT_{g}.

Also, the data repository 310 may include a plurality of M data pieces including data indicative of specific markings XRFM₁, XRFM₂ . . . XRFMₘ that may be used for marking plastic materials and/or products in a recycling process thereof corresponding to/indicating further recycling/reuse of a plastic material in accordance with its current condition. Alternatively (or additionally) such marking relating data may be stored in the internal memory of the management system 100 and the proper data piece is determined/selected by the data processing circuitry (sorting data generator) based on the data received from the database manager system 300.

Thus, the analyzer 142 determines, based on the measured data MD and possibly some a priori known data about a specific plastic material and or product type, the plastic material condition data PMCD. To this end, the management system 100 (analyzer) may generate, based on the received measured data (and possibly some preliminary analysis of the measured data), a request data to the database manager 300. Such request data may be indicative of the measured signature XRFᵢ (e.g. being associated with XRF markings previously embedded in the plastic material) for the specific j-th plastic material PM^{(j)} in a known p-th product type PTₚ corresponding to the i-th preceding use(s) (e.g. i-th recycling stage(s)), i.e. XRFᵢ−PMⱼ−PTₚ.

Based on this request data, the database manager 300 may determine the certificate data C^{(j)}ᵢ of the respective plastic material and communicate this data to the analyzer 142, which then generates the plastic material condition data PMCD to the sorting data generator 144. The latter may analyze this data, by using prestored data in the memory and/or communicating with the database manager system 300, a select a corresponding number t (t≥0) of further allowed recycling/reuse processes and possibly (in case t≠0) at least one corresponding product type PT₁ (being the same or not as the current product type PTₚ) for said plastic material and generate sorting data, PM^{(j)}ₜ−PTₗ. This data is utilized by the certificate data generator 148 to generate updated certificate data CD^{(j)}ₜ and store this in the system memory 120 and possibly also generate corresponding certificate update notification to the database manager system 300.

It should be noted that the case may be such that the analyzer 142 is preprogrammed to analyze the measured data MD and determine the plastic material condition data PMCD, i.e. data indicative of the number i of the already undergone recycling processes for specific j-th plastic material PM^{(j)}ᵢ contained in specific p-th product type PTₚ (corresponding to the current certificate data C^{(j)}ᵢ of the plastic material), and communicate this data to the sorting data generator 144. The sorting data generator 144 may communicate with the database manager system 300, as described above, to determine sorting data PM^{(j)}ₜ−PTₗ; and this data is utilized by the certificate data generator 148 to generate updated certificate data CD^{(j)}ₜ and store this in the system memory 120 and possibly also generate corresponding certificate update notification to the database manager system 300.

The marking data generator 146 then utilizes the sorting data and communicates with the data management system 300 (or may be utilizes relevant data pre-stored in the memory 120 of the management system 100, as the case may be) to determine/select the proper h-th marking data piece XRFMₕ from the plurality of M marking data pieces to mark the plastic material in accordance with the sorting data.

In some cases, at least one of the S signatures may be associated with one or more plastic materials. For example, XRF₂ may correspond to a marking embedded in (detected/read from) a first plastic material type PM⁽¹⁾₁ that has undergone one recycling cycle and/or a marking embedded in (detected/read from) a second plastic material type PM⁽²⁾₃ that has undergone three recycling cycles. That is, given that the plastic material type is known, by measuring the XRF signature of the XRF marking(s) embedded therein, the number of recycling cycles this plastic material type has undergone can be determined.

In some cases, the specific signature may be associated with merely one plastic material type. Therefore, in such cases, the plastic material type and the number of recycling cycles this plastic material type has undergone, both may be determined based on the XRF signature measurement of the XRF marking embedded therein.

In some other cases, more than one XRF signatures may be associated with a given plastic material type. It should also be understood that the case may be such that a product type may be associated with one or more markings and/or one or more plastic material types and/or combinations thereof.

Further, it should be noted that the certificate data indicative of the recycling condition of plastic material may include information related to a given product and/or plastic material type. Such information may include for example, but not limited to, one or more of the following: XRF marker embedded therein, plastic material composition of the product, a ratio between plastic materials forming the product (e.g., as further described herein), presence and/or concentration of contaminant elements and/or impurities (e.g., as further described herein), number of recycling cycles associated therewith, number of additional recycling cycles possible, XRF markers to be introduced during next recycling cycle, an indication identifying the quality or grade of the plastic material(s) and/or product to be recycled and reused, manufacturer, production date, batch number, product distributor, successive product types which may be produced after recycling (i.e. successive product types for reuse of recycled plastic material), future product destination (e.g., a retailer), and/or any combination thereof, and/or any other information relevant thereto.

Referring back to FIG. 1, analyzer 142 can retrieve certificate data CD(j) generated by the data repository 310 for each measured XRF signature (provided by the measured data provider 200), for each given plastic material. The analyzer 142 determines, based on the analysis of the measured XRF signatures and respective certificate data thereof, for each given plastic material, the respective plastic material condition indicative of the number of times the given plastic material has undergone recycling and product type(s) involved. Moreover, based on the analysis it can be determined whether the plastic material (e.g., polymetric material) is a virgin plastic material or a recycled plastic material, that underwent one or more recycling cycles, as further described hereinbelow.

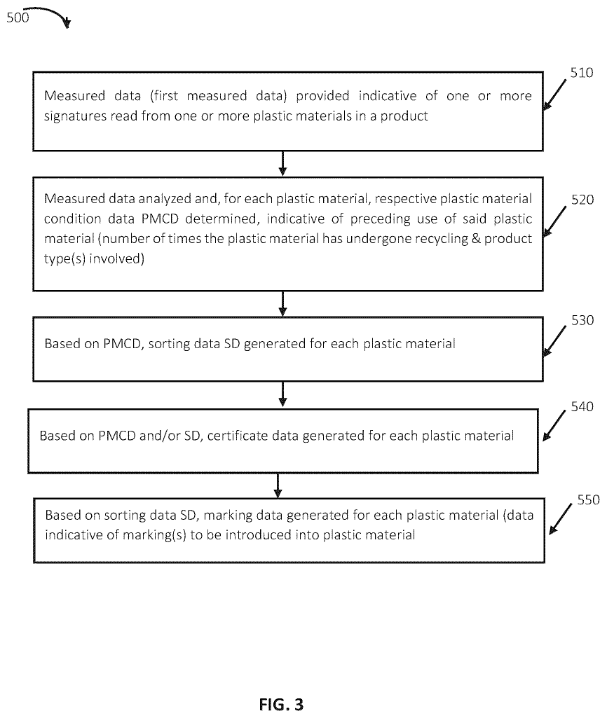

Referring to FIG. 3, there is exemplified, in a self-explanatory manner, a flowchart 500 of a method of the invention for managing plastic material recycling according to the invention. Measured data is provided indicative of one or more electromagnetic radiation signatures of a plastic material or plastic material composition in a product (block 510). For this purpose, data processing circuitry 140 may operate as described above to communicate with measured data provider 200 (external storage system or measurement device) to receive therefrom such measured data obtained in one or more measurement sessions. The XRF signature may be associated with a respective XRF marker that may have been introduced to the plastic material forming a plastic product, e.g., during a polymerization process of the plastic material and/or in a hot melt processing (e.g., extrusion) performed during a manufacturing process of the product, wherein the plastic material contained therein.

Plastic materials may originate from different sources, such as for example different products and/or manufacturers. Some of the products may include a composition of plastic materials having different plastic material conditions. For example, the composition may include a virgin plastic material and recycled plastic material that underwent at least one recycling cycle and marked by one or more XRF markers accordingly. In such cases, the first measured data may include XRF signatures that correspond to the XRF markers embedded in the composition.

In some cases, the method may utilize provision of second measured data indicative of an XRF signal arrived from one or more contaminant elements presented in the plastic material. Contaminant elements and/or impurities may be present in plastic material(s) (e.g., polymeric materials) that form a plastic product. Typically, polymeric materials are of light weight wherein the main contribution to XRF intensity peaks (e.g., XRF peaks with intensity higher than the background level in the spectrum) may be due to contaminant elements and/or impurities that may be present in the polymeric material. Such contaminant elements (e.g., Zn, Ca, Ti, Fe, Ca, Fe) and/or impurities may be detected by an XRF analysis.

In some cases, contaminant elements and/or impurities may originate from production process of the plastic material forming a plastic product, e.g., a contaminated polymerization process of the plastic material, and/or may originate from production process of the plastic product (that in some cases can be made mainly from polymeric material) e.g., a hot melt processing (e.g., extrusion) performed during a manufacturing process of the product.

In other cases, contaminant elements may originate from product usage. For example, the product may be a plastic film or plastic packaging (e.g., a plastic film wherein LDPE comprised therein as a polymeric material) that may be used in close physical contact with other products and/or materials from which contaminant elements may for example diffuse into the plastic film or plastic packaging.

The measured data is analyzed as described above to determine, for each of the one or more plastic materials, a respective plastic material condition data PMCD, indicative of preceding use of said plastic material (a number of times the plastic material has undergone recycling & product type(s) involved)—block 520.

Generally, plastic material condition data may indicate one or more of the following: number of times a given plastic material has undergone recycling, data indicative of whether the plastic material (e.g., polymetric material) is a virgin material or a recycled plastic material, a ratio between the plastic material and a predetermined natural material (e.g., a virgin material) contained in the product. As described above, in some cases, measured data may be analyzed to identify contaminant elements (e.g., foreign elements) and/or impurities contained in a plastic product or plastic material forming the product to assess their concentration therein. In other cases, where applicable (e.g., a product made of a composition of plastic materials wherein each has a different plastic material condition), measured data may be analyzed to determine relative portions of virgin material and recycled plastic material in the composition of plastic materials forming the product, and optionally relative portions of each of the recycled plastic materials with respect to the relative portion of the overall recycled plastic materials comprised by the composition.

Based on the plastic material condition data, sorting data (first sorting data) is generated as described above for each of said one or more plastic materials (block 530). For example, in some cases where plastic products are made from the same type of plastic material, sorting data may sort/distinguish each product into one-time products that include plastic materials that were recycled once, two-times products that include plastic materials that were recycled twice and so forth. In other cases, where plastic products are made from two or more different types of plastic materials, such as for example comprising virgin polymeric material and one or more k-times recycled polymeric materials, sorting data may sort/distinguish the plastic products in accordance with a preselected criterion. For example, the criterion may be a given plastic material composition of the product (e.g., predetermined proportions of virgin polymeric materials and k-times recycled polymeric materials). In some cases, for example, the criterion may be a preselected percentage range (e.g., 10-20%, 20-30%, etc.) of virgin polymeric material comprised by the plastic material composition.

In some cases, the sorting data may be generated based on the certificate data associated with the plastic product and/or plastic material(s) forming the product. That is, the sorting data may be generated based on one or more of the following: XRF markers embedded in the plastic product and/or plastic material(s) forming the product, plastic material composition of the product, a ratio between plastic materials forming the product, presence and/or concentration of contaminant elements and/or impurities, number of recycling cycles associated therewith, number of additional recycling cycles possible, XRF markers to be introduced during next recycling cycle, manufacturer, production date, batch number, product distributor, successive product types which may be produced after recycling (i.e. successive product types for reuse of recycled plastic material), future product destination (e.g., a retailer), and/or any combination thereof, and/or any other information relevant thereto. In some cases, sorting data generated by sorting data generator 144 may include at least one XRF marker corresponding to: a number of the successive life cycles of the plastic material to be recycled and reused, and a successive product type for reuse of recycled plastic material.

Based on PMCD and/or SD, certificate data is generated for each plastic material of interest as described above (block 540).

Further, sorting data is used to generate marking data for each plastic material of interest (block 550), i.e. data indicative of marking(s) to be introduced into plastic material for further managing a recycling/reuse process thereof. Marking data may be generated based on the first sorting data and may include one or more markers to be introduced into the plastic product and/or plastic material(s) forming the product during next recycling process thereof. In some cases, at least one XRF marker may be selected from a predetermined database, which stores, for each plastic material reuse type (e.g., plastic materials to be recycled and reused), data indicative of a successive life cycles (e.g., number of additional recycling cycles possible) of said plastic material in association with matching data about corresponding one or more XRF markers.

In some cases, marking data may be generated based also on second measured data (that in turn may be based on second sorting data) indicative of XRF signal(s) arrived from one or more of contaminant elements and/or impurities that may be present in the plastic product and/or plastic material(s) forming the product. In such cases, marking data may include one or more markers to be introduced into the plastic product and/or plastic material(s) forming the product during next recycling process thereof, wherein these markers are selected so that they will not interfere with the XRF signals of the contaminant elements and/or impurities. For example, upon inspecting plastic product and/or plastic material(s) forming the product with an XRF reader, contaminant elements may emit a response signal with relatively high intensity at certain energies (e.g., frequencies). Therefore, in such cases marking data may include one or more XRF markers to be introduced into the plastic material during next recycling process thereof, wherein these markers may be selected so that the signals they emit (e.g., upon XRF inspection) are of different frequencies than the high intensity signals of the contaminant elements.

In some cases, the second measured data is determined by performing one or more XRF measurement sessions, on a plastic product and/or one or more plastic materials that form a plastic product, being classified by the sorting data to identify the XRF signals and generate the second measured data indicative thereof.

It should be noted that the certificate data (updated certificate) may include data indicative of the preceding certificate data or at least a part thereof such as manufacturer, production date, batch number, product distributor, successive product types which may be produced after recycling (i.e. successive product types for reuse of recycled plastic material), future product destination (e.g., a retailer), and/or any combination thereof, and/or any other information relevant thereto.

Typically, in a recycling process of plastic materials (e.g., polymeric materials) and/or plastic products, the plastic materials undergo hot melt processing (e.g., extrusion) to produce new products made from recycled plastic materials. In an example, the plastic material is fed into an extruder and extruded into filaments and then chopped into beads or pellets as the recycled product. One or more markers may be fed into the extrusion process via a standard feeder or hopper in the form of pellets, powder, or liquid.

During a recycling process of plastic materials, additives may be added therein, typically in the form of a masterbatch, in order to improve various properties of these plastic materials which may diminish due to the recycling process and to prior use of the plastic materials in a product before recycling. For example, additives may be added to improve desired mechanical properties such as strength and elasticity, optical properties such as transparency, color, gloss, thermal properties and other properties including stabilization against degradation by oxygen, heat and/or light, etc. The additives are commonly added in the form of a masterbatch during extrusion or other hot melt processing methods. According to the presently disclosed subject matter, the one or more markers may be introduced to the plastic material, during recycling process thereof, in a single package together with additional additives in a single masterbatch. This form of embedding one or more markers into the plastic material is advantageous, as it can be carried out without additional equipment (e.g., additional feeders) or adjustments to standard extrusion facilities.

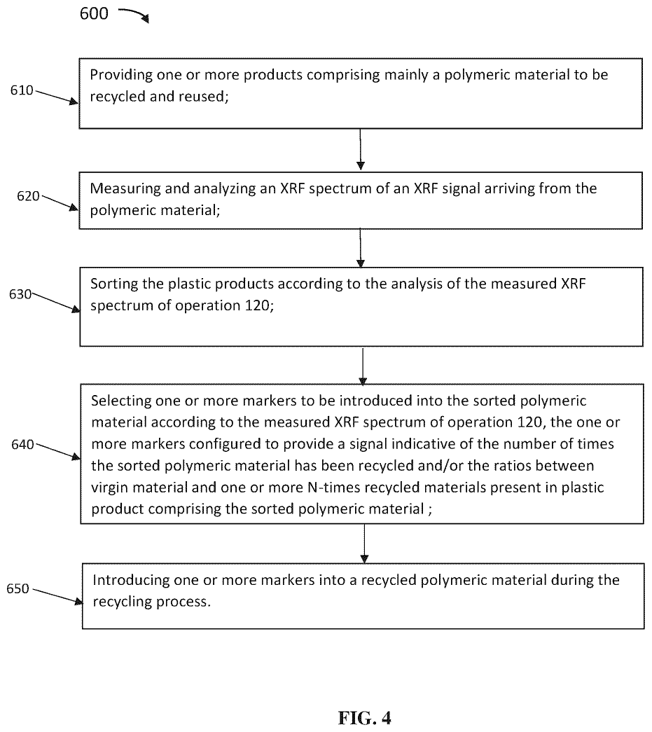

Reference is now made to FIGS. 4, 5 and 6 showing flow diagrams of methods according to some specific but not limiting examples of the invention.

In the example of FIG. 4, the method diagram 600 is illustrated where the plastic material condition data is determined based on estimating the relative part of virgin polymeric material and a recycled polymeric material in a plastic product during the manufacturing of the product or after production, that is estimating the relative parts from the obtained product. More specifically, one or more products are provided comprising a polymeric material to be recycled and reused (step 610). In general, the polymeric material is the main component of the one or more products. For example, the products are plastic films or plastic packaging and comprise as main components polymeric materials, which may of one or more of the following types: low density polyethylene (LDPE), linear LDPE (LLDPE), high density polyethylene (HDPE), poly ethylene terephthalate (PET), polypropylene (PP), polyamide (PA), thermoplastic polyurethane (TPU), polystyrene (PS), high impact polystyrene (HIPS), polylactic acid (PLA), or polyvinylchloride (PVC). Especially, plastic films or plastic packaging are comprised mainly of LDPE or LLDPE.

The plastic material may be a natural polymeric material such as rubber or latex, which may be used by itself or in combination with an industrial or synthetic plastic polymer.

A first XRF spectrum of an XRF signal arriving from the one or more products is measured and analyzed (step 620) to detect XRF signature of one or more XRF markers which indicates whether the polymetric material is a virgin polymeric material or a recycled polymeric material which has already undergone one or more recycling processes. The one or more markers which indicate that the recycled polymeric material has undergone recycling have been introduced during the recycling process (as described below). These markers also indicate the number of times the polymeric material has been recycled.

The polymeric material may also include one or more XRF markers which were introduced into the polymeric material during polymerization, i.e. resulting in a marked virgin polymeric material, or compounding or during hot melt processing (e.g. extrusion) for instance during production of a product containing the polymeric material. The one or more markers may indicate that the polymeric material is a virgin polymeric material which was not yet recycled. Additionally, the one or more XRF markers may be used to indicate for example the type of the product (e.g., its composition comprising mainly one or more polymeric materials), as well as the manufacturer of the polymeric material or the manufacturer of the product, the date of production of the product, a batch number of the product the distributor of the product, the destination of the product (e.g. a retailer) as well as further other information of the product (categories).

The sorting data is generated (step 630) allowing sorting the products, according to the number of times a polymeric material included in the individual products has undergone recycling. Namely, the products may be separated into one-time products including polymeric materials that were recycled once, two-times products that include materials that were recycled twice and so forth. Moreover, products comprising two or more polymeric materials, for example comprising virgin material and one or more N-times recycled polymeric materials, may be sorted according to a preselected criterion determined by the relative proportions of virgin materials and N-times recycled polymeric materials (i.e. the composition of the polymeric material) and by deciding on a preselected criterion, whether the product is a first-time product, a two-times product and so forth.

The results of data analysis performed as described above may also allow to sort the products according to manufacturer, destination or intended user (e.g. a retailer or a distributer) and further other information relating to the product (categories).

Based on the sorting date, one or more markers are selected (step 640) to be introduced into the recycled polymeric material according to the measured XRF spectrum. The one or more markers to be introduced into the recycled polymeric material during the recycling process are adapted to provide an indication that the material has undergone a recycling process as well as the number of times the polymeric material has been recycled. Additionally, the selected markers may be adapted to provide an indication as to the composition of the recycled polymeric material (i.e. indication the ratio between virgin material and recycled polymeric materials as well as between different N-times recycled polymeric materials). Furthermore, the one or more markers may provide an indication identifying the quality or grade of the recycled polymeric material, the recycling facility, the destination of the recycled polymeric material, date of production, batch number and so on.

It should be understood that the marking data (one or more markers) is preferably selected such that contaminants and/or impurities present in the polymeric material will not interfere with the detection and identification of the markers. Namely, upon inspecting the recycled polymeric material with an XRF reader, the contaminants might emit a response signal with relatively high intensity at certain energies (frequencies), while the markers to be introduced into the recycled polymeric material are selected so that the signals they emit (upon XRF inspection) are of different frequencies than the high intensity signals of the contaminants.

Then one or more markers is/are introduced into a recycled polymeric material during the recycling process (step 650), in which the polymeric material to be recycled (commonly after washing and shredding) undergoes a hot melt process to produce a new product, which comprises recycled polymeric material. In an example, the polymeric material is fed into an extruder and extruded into filaments and then chopped into beads or pellets as the recycled product. The one or more markers may be fed into the extrusion process via a standard feeder or hopper in the form of pellets, powder, or liquid.

As described above, in the production of recycled polymeric materials additives, usually in the form of a masterbatch, are commonly added to the recycled polymeric material in order to improve various properties which may diminish due to the recycling process and to prior use of the polymeric material in a product before recycling. For example, additives may be added to improve desired mechanical properties such as strength and elasticity, optical properties such as transparency, color, gloss, thermal properties and other properties including stabilization against degradation by oxygen, heat and/or light. The additives are commonly added in the form of a masterbatch during extrusion or other hot melt processing methods. The one or more markers may be introduced into the recycled polymeric material in a single package together with additional additives in a single masterbatch. This form of embedding one or more markers into the recycled polymeric material is advantageous, since it can be carried out without additional equipment (e.g. additional feeders) or adjustments to standard extrusion facilities.

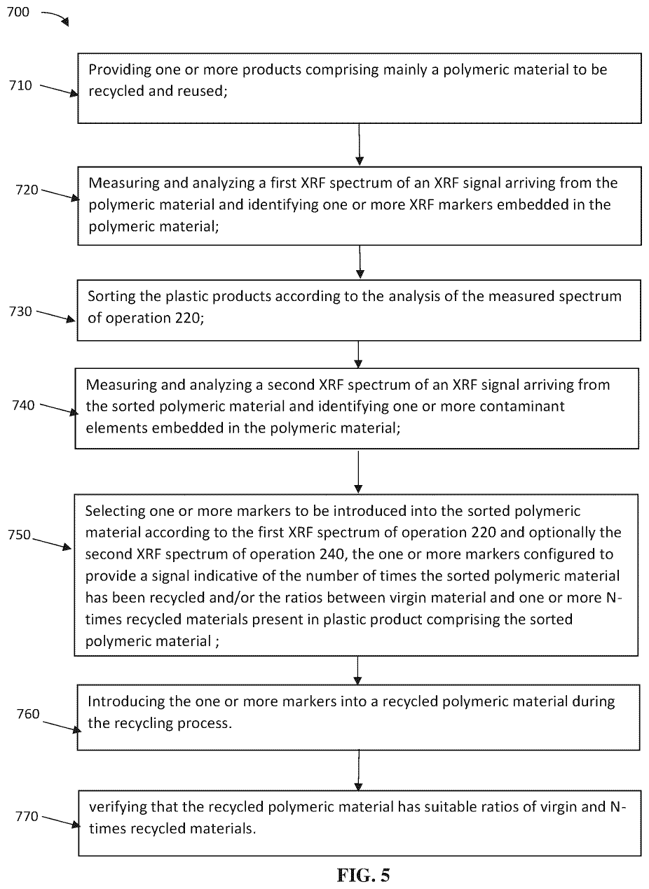

FIG. 5 exemplifies a flow diagram 700 for managing the recycling of polymeric materials according to some other embodiments of the present invention. Similarly, one or more products comprising a polymeric material to be recycled and reused are provided (step 710). In general, the polymeric material is the main component of the one or more products. First XRF spectrum of an XRF signal arriving from the polymeric material in one or more plastic products is measured and analyzed (step 720) to detect XRF signature of one or more XRF markers. The one or more XRF markers might have been introduced to the polymeric material during recycling and provide an indication as to the number of times the polymeric material has been recycled. In addition, some of the XRF markers might have been introduced during the production of the virgin polymeric material and may provide indication as to the manufacturer of the polymeric material or that of the product, the date of production of the product, batch number of the product, the distributor, the destination of the product (e.g. retailer) as well as further other information (categories).

The polymeric materials may originate from several sources and products/manufacturers. Some of products may include polymeric materials which include a blend of both a virgin polymeric material and recycled polymeric material which has already undergone recycling and marked by one or more XRF markers. These one or more XRF markers would be detected by the first XRF measurement. Furthermore, by analyzing the XRF spectrum one may obtain the relative portions of virgin polymeric material and recycled polymeric material as well as the relative portions of each of the N-times recycled polymeric material (N-times recycled being polymeric material recycled N times).

Sorting data is generated (step 730) allowing sorting the products to be recycled according to the measured XRF spectrum. The products may be sorted according to the number of times the polymeric material included in the products has undergone recycling. Furthermore, blended polymeric materials (comprising virgin polymeric material and one or more N-times recycled polymeric material for one or more N values) may be sorted according to a preselected criterion determined by the relative portions of virgin and N-times recycled materials. For example, the sorting may group in a batch (to be further processed in a similar way) products which include virgin polymeric material between preselected percentages (e.g. 10-20%, 20-30%, and so on). Additionally, the products may be sorted according to additional criteria which may be inferred from the XRF markers embedded in the polymeric material, for example according to manufacturer of the product, destination or intended user (e.g. a retailer or a distributor) of the product and other further information (categories).

Then, second XRF spectrum of the sorted polymeric material may be measured and analyzed (step 740) in order to obtain a second XRF signature relating to contaminants which may be present in each of the batches of the sorted polymeric material. The sorted polymeric material may undergo grinding or shredding before the measurement, which is carried out so as to obtain a spectrum corresponding to an average concentration of contaminant over a batch of the sorted polymeric material. This can be achieved, for example, by collecting a second XRF signal over a time period during a relative movement of the inspected sorted polymeric material and the XRF reader (e.g. moving the inspected material on a conveyor). Analysis of the measured second XRF spectrum may be used to identify a characteristic XRF signatures corresponding to one or more elemental peaks in the spectrum associated with contaminants in the sorted polymeric material.

Marking data is generated (step 750) which is indicative of one or more selected markers to be introduced into the sorted polymeric material according to the measured first XRF spectrum associated with one or more markers embedded in the polymeric material, and, optionally, the second XRF spectrum associated with one or more contaminant elements which may be present in the sorted polymeric material.

The marking data can then be used to introduce the selected one or more markers into the sorted polymeric material during the recycling process (step 760). In the recycling process the sorted polymeric material undergoes a hot melt process to produce a recycled polymeric material. In an example the sorted polymeric material is fed into an extruder and extruded into filaments and then chopped into a product in the form of beads or pellets. The one or more markers may be fed into the extrusion process via a standard feeder or hopper in the form of pellets, powder, or liquid.

The one or more markers are added to the recycled polymeric material as a single masterbatch together with various plastic additives generally in a similar manner to process described above. In the production of a product containing recycled polymeric materials various batches sorted as described above may be blended at the extruder together with virgin materials to from a recycled product containing virgin material and N-times recycled polymeric material in preselected ratios. Alternatively, virgin material may be blended with the recycled polymeric material not during the recycling process itself but at a later stage, for example at a mixing at room temperature or for example during the production process of a product. In a more specific example, the product may be a plastic film (e.g. a plastic film which comprises mainly LDPE or LLDPE) in which production virgin polymeric material and recycled polymeric material are blended in a hot melt process.

Then, a verification process is performed (step 770) to verify that the recycled polymeric material has a suitable composition in terms of ratios of virgin polymeric materials and N-times recycled polymeric materials by XRF analysis (i.e. inspecting the polymeric material with an XRF analyzer and analyzing the obtained third XRF spectrum). In estimating the ratios, one may rely on both the markers embedded in the polymeric materials in various stages of recycling and production; and the contaminants characterizing the batch or batches of polymeric materials used in the production of the recycled polymeric material. In an example, one may determine the number of recycling processes (or the highest number of recycling processes undergone by at least a portion of the recycled polymeric material) by measuring the corresponding markers embedded in the polymeric material during the recycling process and estimate the ratios of the N-times recycled polymeric materials and the virgin materials according to the measurement of the contaminants present in the recycled polymeric materials.

The verification of the composition of the recycled polymeric material may be utilized for quality assurance of the recycling process ensuring the quality of the process and the recycled material. Additionally, the verification may be used for quality assurance of a production process of a product comprising the recycled polymeric materials. Furthermore, the verification may be carried out at the next recycling process once the polymeric material when a product including the polymeric material ends another life cycle at the recycling facility. The verification process provides control data characterizing the recycling process of the specific plastic material and/or production process of product(s) comprising such plastic material.

Furthermore, as the markers are embedded within the polymeric material and may be read (measured) also as a component in a product, the verification may be utilized to verify to a user that the polymeric material is made of recycled polymeric material or that it contains a selected quantity of recycled polymeric material. The verification can be utilized in a credit scheme for plastic recycling wherein the user purchasing a recycled product, the recycling party, or the previous user receive credits points or recycling a selected quantity of products.

It should be noted that measured XRF spectrum or XRF spectra (measured for the purposes of plastic material inspection stage described above as well as that/those measured in the verification process) and/or information encoded by the XRF spectrum or XRF spectra (e.g. the amount of virgin vs. recycled materials) may be uploaded (for example by the XRF readers or by other devices) and stored in a cloud system. The cloud system may be used to manage a ‘green’ credit system for the various parties involved in the recycling, for example manufacturers of various polymeric materials or products, suppliers of polymeric materials or products, retailers of products and the end users of products. In an example the cloud system may be a distributed blockchain system. For example, the blockchain systems described in WO 2018/207180, WO 2019/175878, and WO 2021/070182, all assigned to the assignee of the present application and incorporated herein by reference.

In some other embodiments of the present invention, the second XRF spectrum which is configured to provide an XRF signature of contaminant elements present in the sorted polymeric material, is carried out after the recycling process in which the one or more XRF markers are introduced into a recycled polymeric material.

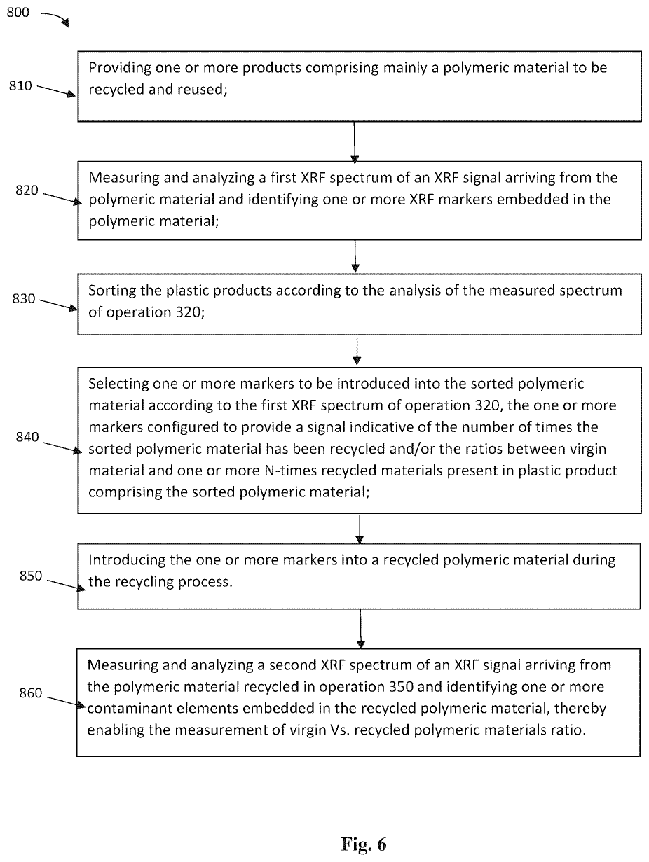

FIG. 6 exemplifies a flow diagram 800 of the method according to yet another embodiment of the present invention. Here, similarly to the previous examples, one or more products comprising a polymeric material to be recycled and reused are provided (step 810); a first XRF spectrum of an XRF signal arriving from the polymeric material in one or more products is measured and analyzed (step 820); sorting data is generated (step 830) according to the measured XRF spectrum, as described above. Then, marking data is generated (step 840) indicative of one or more selected markers to be introduced into the sorted polymeric material according to the measured first XRF spectrum associated with one or more markers embedded in the polymeric material.

The one or more markers may be introduced into a sorted polymeric material during the recycling process (step 850) generally similar to the above-described example. Then, a second XRF spectrum of a signal arriving from the recycled polymeric material (that is, from the sorted polymeric material after undergoing the recycling process) is measured and analyzed (step 860). This second XRF spectrum may include signals (intensity peaks) indicative of the one or more XRF markers introduced in the recycling process, and XRF markers which where embedded in the sorted polymeric material previously (in previous recycling processes and possibly as a virgin polymeric material). Additionally, the XRF spectrum may include signals from contaminant present in the recycled material. These contaminants might be present in various products that have been sorted. After the recycling process, which includes hot melt processing, these contaminants are homogeneously distributed in the recycled polymeric material. These contaminants can therefore be used, possibly in combination with the one or more markers, as an XRF signal of the recycled polymeric material. This signature can be utilized to measure the ratio between recycled polymeric material and virgin polymeric material in any plastic product in which the recycled polymeric material will be used. Once the recycled polymeric material is blended with virgin polymeric material (in a product) the intensity of the XRF signature will decrease enabling the assessment of the virgin vs. recycled ratio. The one or more XRF markers may be used to determine the number of times the recycled polymeric material within a product has been recycled.

The following are a few specific but not limiting examples of markers suitable to be used marking of a recyclable plastic material and/or natural material forming characteristic signature(s) of the marked material(s) or a product containing such marked material(s); the marking techniques; and the detection/reading techniques.

### Example 1: The Markers

Generally speaking, the XRF signature is formed by adding to the polymer, by any means known in the art, any amount of an XRF-marker that may be a molecule or an atom that is XRF-identifiable. The molecule may be any such molecule comprising an atom of the periodic table that is XRF-identifiable. The atom may be presented as a salt, a complex, an organic compound or an inorganic compound. For example, where the marker is a metal or a metal containing material, e.g., organometallic material, or metal salt the metal atom may be selected from aluminum (provided as e.g., aluminum sulfate), titanium (provided as, e.g., titanium sulfate), cobalt (provided as e.g., cobalt nitrate hexahydrate, cobalt gluconate hydrate, cobalt glycinate), nickel (provided as nickel nitrate hydrate, nickel glycinate), yttrium provided as e.g., yttrium nitrate hexahydrate), cadmium (provided as e.g., cadmium nitrate tetrahydrate), tin (provided as e.g., tin chloride), scandium, niobium, silver, tungsten, zinc, zirconium, manganese, copper, lead, molybdenum, vanadium, bismuth, antimony, tantalum and cesium (provided as e.g., cesium carbonate). Other metals are useful as well.

Other metal-based markers may be provided in a water-insoluble form. Such include aluminum oxide, scandium acetate, titanium oxide, cobalt acetyl acetonate, cobalt carbonate, cobalt dibromo, nickel acetyl acetonate, nickel acrylate, yttrium oxide, niobium oxide, silver carbonate, silver chloride, tin ethyl hexanoate, tungsten oxide and others.

Halide-based markers include tri-iodine phenol (TIP), tribromophenol (TBP), tri chlorophenol (TCP), 2,2-bis(bromomethyl) propane-1,3-diol, 2,4,6-tribromo aniline, pentabromobenzyl acrylate, 4,5,6,7-tetrabromoisobenzofuran-1,3-dione, ammonium bromide and others.

The markers may be water soluble or water-insoluble.

Markers are added to the polymer at any stage of its manufacturing or use. The markers may be added once the polymer is formed, or in case of a naturally occurring material such as natural rubber, once it is added prior to further processing or during its processing. The marker may be added by mixing directly into the polymer resin or raw material or embedded within the polymer during processing. The markers may be added neat or may be added in a chelated form.

### Example 2: Preparation of Marked Rubber Samples 1

Natural rubber was collected and was treated with water soluble and water insoluble markers. In either case, an amount of the marker was added into the rubber (latex) prior to further polymerization and processing based on the amount of the rubber to be marked (namely at a predefined concertation). The marker was selected based on its composition, amount and distribution to provide an identifiable XRF signature.

The water-soluble marker was added as a water solution, by adding the solution dropwise into a stirred/mixed rubber sample. In the case of a water-insoluble marker, an amount was added neat, or could be added in, e.g., an organic medium, into the rubber and stirred/mixed. Samples were stirred until homogenous distribution of the marker was achieved.

### Example 3: Preparation of Marked Rubber Samples 2

In a similar fashion to the addition described in Example 2, markers were added to rubber samples by milling rolls.

### Example 4: Reading of XRF Signal from Polymeric or Rubber Samples

Samples marked as above, which included plastic samples and rubber samples, were read by XRF according to methods described herein to identify the XRF signatures derived from earlier marking.

In all samples readings identified the signatures indicative of the samples.

1-46. (canceled)

47. A method for managing material recycling process comprising: providing first measured data indicative of one or more first electromagnetic radiation signatures embedded in one or more plastic materials in a product;
analyzing the measured data to determine, for each of said one or more plastic materials, a respective plastic material condition data, wherein the respective plastic material condition data is indicative of preceding use of said plastic material;
generating first sorting data for each of said one or more plastic materials, based on the respective plastic material condition; and
generating marking data for at least one of said one or more plastic materials, based on the first sorting data, wherein the marking data includes data indicative of at least one marker to be introduced into each of said one or more plastic materials to provide electromagnetic radiation signal for managing a recycling process said one or more plastic material.

48. The method according to claim 47, further comprising utilizing at least one of the plastic material condition data and the sorting data of said plastic material, and generating and storing certificate data charactering a current condition of said plastic material to be sorted.

49. The method according to claim 47, wherein, for each of said one or more plastic materials, the respective plastic material condition is indicative of a relation between said plastic material and a predetermined natural material contained in the product.

50. The method according to claim 49, wherein said first measured data comprises data indicative of one or more electromagnetic radiation signatures of said predetermined natural material.

51. The method according to claim 47, further comprising communicating the marking data to a marking system configured and operable to be responsive to the marking data in association with the one or more plastic materials in the product, and performing one or more marking sessions to introduce said at least one marker into each of said one or more plastic materials.

52. The method according to claim 47, further comprising utilizing said marking data in association with the one or more plastic materials in the product and operating a marking system to perform one or more marking sessions to introduce said at least one marker into each of said one or more plastic materials.

53. The method according to claim 47, further comprising providing second measured data indicative of one or more second electromagnetic radiation signals originated by one or more contaminant elements presented in the plastic material after being sorted by introducing said marking therein.

54. The method according to claim 48, further comprising providing second measured data indicative of one or more second electromagnetic radiation signals originated by one or more contaminant elements presented in the plastic material after being sorted by introducing said marking therein, and updating the certificate data characterizing the plastic material.

55. The method according to claim 53, wherein said providing of the second measured data comprises at least one of the following: communicating with a measured data provider to receive said second measured data from the measured data provider; and performing one or more measurement sessions on said product after being sorted to identify the one or more second electromagnetic radiation signatures and generate the second measured data indicative thereof.

56. The method according to claim 47, further comprising: providing verification data indicative of composition of the plastic material being recycled based on said marking data embedded in the plastic material; analyzing the verification data and generating control data characterizing at least one of the following: the recycling process of said plastic material; a production process of a product comprising the recycled plastic material.

57. The method according to claim 56, wherein said providing of the verification data comprises measuring electromagnetic radiation signals originated in the plastic material being recycled based on said marking data embedded in the plastic material.

58. A system for carrying out the method of claim 47, the system being configured as a computer system comprising data input and output utilities, a memory and a processing circuitry, wherein said processing circuitry is responsive to the measured data to carry out the following:
analyze the measured data to determine, for each of said one or more plastic materials, a respective plastic material condition data indicative of preceding use of said plastic material;
based on the respective plastic material condition data, generate sorting data for each of said one or more plastic materials; and
based on the sorting data, generate marking data for each of said one or more plastic materials, wherein the marking data includes at least one marker to be introduced into each of said one or more plastic materials to provide electromagnetic radiation signal for managing a recycling process of the plastic material.

59. A management system for use in managing material recycling process, the system being configured as a computer system comprising data input and output utilities, a memory and a processing circuitry, wherein:
the data input utility is configured to receive input data comprising first measured data indicative of one or more electromagnetic radiation signatures embedded in one or more plastic materials in a product;
said processing circuitry comprises:
an analyzer configured and operable to be responsive to the first measured data to analyze it and determine, for each of said one or more plastic materials, a respective plastic material condition indicative of preceding use of said plastic material;
a sorting data generator configured and operable to determine sorting data for each of said one or more plastic materials, based on the respective plastic material condition; and
a marking data generator configured and operable to determine marking data for each of said one or more plastic materials, based on the sorting data, wherein the marking data includes at least one marker to be introduced into each of said one or more plastic materials to provide electromagnetic radiation signal for managing a recycling process of the plastic material.

60. The management system according to claim 59, configured and operable to communicate with a measured data provider to receive said first measured data from the measured data provider, and/or wherein the system is configured and operable to communicate the marking data to a marking system configured and operable to perform one or more marking session to introduce said at least one marker into each of said one or more plastic materials.

61. The management system according to claim 59, further comprising a measurement unit configured and operable to perform one or more measurement sessions on said product to identify said one or more signatures and generate the first measured data indicative thereof.

62. The management system according to claim 59, further comprising a marking unit configured and operable to perform one or more marking sessions to introduce said at least one marker into each of said one or more plastic materials.

63. The management system according to claim 59, wherein said processing circuitry further comprises a certificate generator utility configured and operable to utilize at least one of the plastic material condition data and the sorting data of said plastic material, and generate and store certificate data charactering a current condition of said plastic material to be sorted.

64. The management system according to claim 59, further configured and operable to receive and analyze second measured data indicative of one or more second electromagnetic radiation signals originated by one or more contaminant elements presented in the plastic material after being sorted by introducing said marking therein.

65. The management system according to claim 59, further comprising providing second measured data indicative of one or more second electromagnetic radiation signals originated by one or more contaminant elements presented in the plastic material after being sorted by introducing said marking therein, and updating certificate data characterizing the plastic material.

66. The management system according to claim 59, further configured and operable to receive and analyze verification data indicative of composition of the plastic material being recycled based on said marking data embedded in the plastic material; and generate control data characterizing at least one of the following: the recycling process of said plastic material; a production process of a product comprising the recycled plastic material.
